(19) United States
(12) Patent Application Publication
(10) Pub. No.: US 2009/0205209 A1
(43) Pub. Date: Aug. 20, 2009

(54) Folding Spoon Apparatus and Method

(76) Inventor: Cristian Bredee Tovar, Distrito Federal (MX)

Correspondence Address: THE MILLER LAW OFFICES, PLC, 801 BRICKELL AVE, SUITE 900, MIAMI, FL, 33131, US

(21) Appl. No.: 12/032,674

(22) Filed: Feb. 16, 2008

(51) Int. Cl. A47J 43/28

(52) U.S. Cl. 30/324

(57) ABSTRACT

When an individual goes camping, they need to have lightweight easily assembled utensils for eating. The present invention relates to the assembly of a spoon eating utensil that is stored in a completely flat position, and then can be easily assembled and disassembled, in any desired sequence or order, by an individual into complete reusable eating utensil without the use of any external tools, parts, or fasteners.

### CROSS REFERENCE TO RELATED APPLICATIONS

Not Applicable.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of the Invention

The present invention relates to assembly of a spoon eating utensil that is easily stored in a completely flat position, and then can be easily assembled, or disassembled, by an individual, in any desired sequence or order, into complete reusable eating utensil without the use of any external tools, parts, or fasteners.

2. Prior Art

In the prior art, there have been foldable utensils and specifically foldable spoons which were primarily intended for use by campers and other outdoor recreational individuals for easily transporting eating utensils to remote locations. As shown in US Patent Publication Number 20070084064, these utensils primarily consisted of plastic semi-transparent or transparent materials with scored sections that required a very specific sequence of assembly in order to allow for an individual to fold it into a particular shaped utensil. These spoon utensils needed to be plastic materials; they could not be made of metallic materials, needed snaps or similar fasteners to complete and retain the assembly, they needed to be assembled in a specific order, and due to their design, they had short life cycles; i.e. they were necessarily needed to be disposed after one use. The present invention overcomes these aformentioned deficiencies, by allowing the use of metallic materials, no scoring is required, rather the spoon can be manufactured from a simple die cut. The present invention can be assembled by an individual in any order, so it is fool proof. Also, the present invention does not require snaps or similar fasteners to complete and retain the assembly. Due to the ability to use stronger metallic materials, this spoon may be cleaned after each use and used a multitude of times by an individual, much like a camping pocket knife. It has a much longer life cycle and therefore does not require disposal after each use.

### BRIEF SUMMARY OF THE INVENTION

The present invention relates to assembly of a spoon eating utensil that is easily stored in a completely flat position, and then can be easily assembled, or disassembled, in any desired sequence or order, by an individual into complete reusable eating utensil without the use of any external tools, parts, or fasteners.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

In the drawings:

FIG. 1 is a perspective view of the preferred embodiment of the invention, in the fully assembled configuration;

FIG. 2 is a plan view of the preferred embodiment of the invention, with the left side view being in the fully disassembled configuration, and the succeeding views indicating one manner in which to commence assembly.

FIG. 3 is an elevation view of the preferred embodiment of the invention.

FIG. 4 is a plan view of the preferred embodiment of the invention, in the fully assembled configuration.

FIG. 5 is three elevation views of the preferred embodiment of the invention, in the fully assembled configuration.

FIG. 6 is another plan view of the preferred embodiment of the invention, in the fully assembled configuration.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

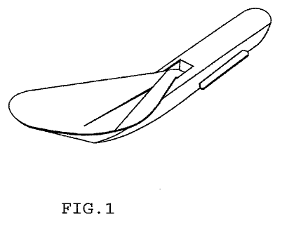

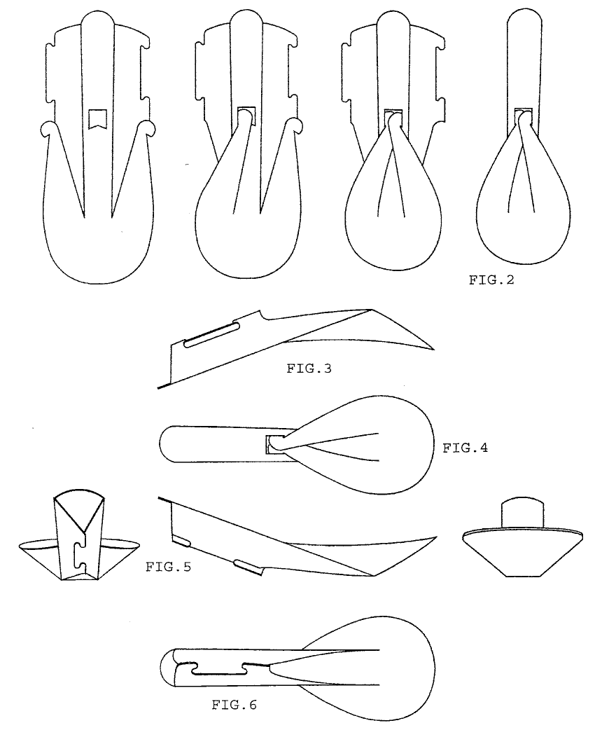

FIG. 1 is a perspective view of the preferred embodiment of the invention, in the fully assembled configuration, and FIG. 2 is a plan view of the preferred embodiment of the invention, with the left side view being in the fully disassembled configuration, and the succeeding views indicating one manner in which to commence assembly. As shown in FIG. 2, an individual starts with a flat completely precut device. The individual may then commence assembly by folding in any of the spoon or handle flaps, in any desired sequence or order, in order for said individual to arrive at the final assembly of the spoon device, as shown in FIG. 3, FIG. 4, FIG. 5, and FIG. 6. Note that no snaps or similar fasteners are required, therefore lending this invention to smoother assembly when compared to the prior art. When reopened or disassembled, again necessarily in any desired sequence or order, the apparatus lends itself to easy cleaning, storage and portability. When assembled, the convex spoon area is larger, and the gap between the convex part and the handle is reduced, when compared to the prior art, thereby enabling the device to better able to retain more viscous liquids, like creamy foods.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A foldable spoon utensil apparatus comprising:
A flat piece of solid material,
said flat materials being precut into a certain geometric shape,
said geometric shape being such that it allows an individual to use said individual's own hands without any other devices, tools or fasteners,
to assemble said flat geometric shaped solid material into a spoon utensil,
wherein any possible sequence of assembly is allowed for an individual to obtain a fully assembled spoon utensil,
and wherein any possible sequence of disassembly is allowed for an individual to obtain a fully disassembled spoon utensil.

2. The apparatus of claim 1 wherein said flat solid material is a metallic material.

3. The apparatus of claim 1 wherein said flat solid material is an organic polymer material.

4. The apparatus of claim 1 wherein said flat solid material is a wood pulp based material.

5. The apparatus of claim 1 wherein said spoon utensil is reusable for a plurality of uses.

6. The apparatus of claim 1 wherein said spoon utensil is disposable after one use.

7. A method for an individual assembling a spoon utensil comprising:
An individual starting with a flat piece of solid material,
said flat materials being precut into a certain geometric shape,
said geometric shape being such that it allows said individual to use said individual's own hands without any other devices, tools or fasteners,
to assemble said flat geometric shaped solid material into a spoon utensil,
wherein any possible sequence of assembly is allowed for said individual to obtain a fully assembled spoon utensil,
and wherein any possible sequence of disassembly is allowed for said individual to obtain a fully disassembled spoon utensil.

8. The method of claim 7 wherein said flat solid material is a metallic material.

9. The method of claim 7 wherein said flat solid material is an organic polymer material.

10. The method of claim 7 wherein said flat solid material is a wood pulp based material.

11. The method of claim 7 wherein said spoon utensil is reusable for a plurality of uses.

12. The method of claim 7 wherein said spoon utensil is disposable after one use.
